(19) United States
(12) Patent Application Publication
(10) Pub. No.: US 2002/0138496 A1
(43) Pub. Date: Sep. 26, 2002

(54) Method and apparatus for processing an online transaction over a communication network

(76) Inventors: Stephan Schambach, Jena (DE); Frank Gessner, Jena (DE); Ulrike Muller, Jena (DE); Christian Mallwitz, Jena (DE)

Correspondence Address: Richard A Nebb, Dergosits & Noah, Suite 1450, 4 Embarcadero Center, San Francisco, CA, 94111, US

(21) Appl. No.: 10/049,148

(22) PCT Filed: Jun. 11, 2001
(86) PCT No.: PCT/EP01/06589

(30) Foreign Application Priority Data
Jun. 9, 2000 (EP) 00112410.6

(51) Int. Cl. G06F 7/00

(52) U.S. Cl. 707/103 X

(57) ABSTRACT

A method of processing an online transaction over a communication network comprises the steps of storing a plurality of objects comprising object data and object attributes containing further information about the object in a catalog server accessible by a plurality of clients, displaying, upon request from a client, an object including object attributes on a client display, and executing, on a transaction server, a transaction relating to an object selected by the client using the information contained in the object attributes, wherein the object attributes are transmitted directly from the catalog server to the transaction server without client interaction. All information necessary for the transaction can therefore be transmitted from the catalog server to the transaction server. The user, however, has no possibility to change these transmitted data.

The present invention is directed to a method, computer system and computer program for processing an online transaction over a communication network as for example the internet.

A catalog server or presentation server is provided for storing a plurality of objects selectable by a user for an online transaction. For the purposes of the following description, an online transaction includes any sort of commercial or noncommercial transaction carried out over a communication network. The entities or individuals taking part in the transaction may be connected to the communication network by any suitable device like server computers, client computers, mobile or wireless devices. A transaction object may be any sort of product or service, relevant data of which are stored in the catalog or presentation server. The stored object comprises object data and corresponding object attributes containing additional information like a detailed description, price, discounts, payment methods and so forth. The attributes may be changed frequently, for example in order to adapt prices to current market conditions and may also be varied dependent on certain circumstances like the number of objects ordered by a client. The presentation server is accessible over the communication network, preferably the internet, by a plurality of clients. A client may be any suitable terminal device like a personal computer, mobile device or cellular telephone operated by an individual user or organization. An object stored in the catalog server can be displayed and presented on a display screen of the client together with the information defined by one or more attributes of the respective object. With such a presentation server the user can only inform himself or herself about the objects available for online purchase. He or she cannot actually order the product or service.

In order to facilitate the purchase of a product or service for the customer it becomes increasingly possible, in addition to the mere presentation of products and services, to carry out business transactions over electronic communication media.

For this purpose order systems are installed on computer servers, which receive or register orders from a customer and carry out the transaction or at least provide an automatic preparation for completing the order including shipment of the products to the customer. For the transaction system a transaction server separate from the presentation server may be employed. It is also possible to use different transaction servers for different products or different manufacturers of products which are presented on one common presentation server.

For carrying out an online transaction the customer can first browse through the products and services offered by the presentation server. The customer can then select desired items or objects by mouse click or the like. These items are part of an order list or virtual shopping cart. For finishing the online transaction the customer then has to type in his or her name, delivery address and credit card number. The order may then be completed by final confirmation of the customer.

In some cases it is also possible for the customer to select among different delivery and payment methods. The client can also initiate specific processes on the transaction server through his or her own entries in the form of parameters or text strings. A simple example for this is that the customer types in his or her name and address in the corresponding text field. These data are subsequently stored in a database of the corresponding transaction server. For the transmission of the text string containing name and address of the customer the URL of the transaction server may be used. The button “register” or “complete order” displayed on a client device contains an HTML tag connected to the URL of the corrresponding transaction server. The customer data are then transmitted to the URL of the transaction server. There is also a command for initiating a program on the server which receives the text string containing the customer data and saves the same for example in the database of the transaction server.

In a transaction or order system not only customer data like the address but also information from the seller like e.g. the price of a product selected by the customer are necessary for the transaction. In order to achieve a fast and reliable execution of an online transaction the necessary processes are automated to the greatest possible extend. It is for example preferable to use the product particulars of the supplier as basis for the transaction.

As already mentioned it is possible that the order system and the catalog or presentation system are installed on two separate server systems. This separation has advantages for maintenance and scalability. The transaction server, for example, can be connected with a plurality of catalog servers.

In this case all necessary particulars of a supplier regarding the product, for example the description, quantity, price etc., which are stored in the data base of the catalog server merely for the purpose of customer information, must be transferred from the catalog server to the transaction server. It is known to store this particulars or additional product information as attribute to the product in the data base. If a customer for example chooses product “A” for display of detailed information thereto, the catalog server retrieves the information stored as object attributes from the data base and integrates the information in an HTML or WML page which can be viewed by the customer. On this page the product is described in detail including e.g. the price. Moreover, there may be a button designated “put into shopping cart”. This button is coupled to an HTML tag including the URL of the corresponding transaction server. Upon generation of the HTML page the designation of the product, in this case product “A” including the related attributes containing description, price etc. are appended to the URL of the HTML tag. If the client designates the button e.g. by mouse-click the browser is instructed to call the URL. The server then starts running a program so that product “A” with accompanying price is stored in the transaction server for following transactions. In this case, however, the problem arises that the customer has the possibility to change the object data like the price of the product.

To avoid this problem it is known to encrypt the object information appended to the URL of the server so that the customer is not able to change this information. The encryption process, however, is complicated and time consuming since encryption and decryption processes are necessary for every transaction. This slows down the execution speed and increases the processing load of the transaction server. Another problem is that the object information or object attributes transmitted to the client maybe updated frequently, for example a product price which depends on volatile market conditions. In these cases it is therefore necessary to invalidate the respective information within short time periods. The updated information must then be transmitted again to the client.

It is therefore an object of the present invention to provide an online transaction method and an appartus and a computer program for carrying out an online transaction over a communication network that avoids the before mentioned problems. It is a further object of the present invention to propose an online transaction system comprising separate presentation and transaction servers which allows a secure and updated transmission of information connected with an object selected by a client from the catalog server to the transaction server for carrying out the online transaction.

The present invention solves this object by providing a method of processing an online transaction over a communication network comprising the steps of storing a plurality of objects comprising object data and object attributes containing further information about the object in a catalog server accessible by a plurality of clients, displaying, upon request from a client, an object and corresponding object attributes on a client display, and executing, on a transaction server, a transaction relating to an object selected by the client using the information contained in the object attributes, wherein the object attributes are transmitted directly from the catalog server to the transaction server.

The present invention further proposes a method of processing an online transaction over a communication network comprising the steps of storing in a catalog server a plurality of objects comprising object data and object attributes containing further information about the object and further storing an ID identifying the object, transmitting upon request an object together with the corresponding object ID from the catalog server to a client for display, receiving at the catalog server an object request from a transaction server, the request including the object ID, returning to the transaction server the object including object attributes corresponding to the received object ID.

Still further the present invention provides a method of processing an online transaction over a communication network comprising the steps of receiving at a transaction server a transaction request with respect to a specific object comprising object data and object attributes containing further information about the object, the request including an object ID identifying that object, requesting the object from a catalog server, the request including the object ID, receiving at the transaction server from the catalog server the selected object including object attributes, and executing the transaction on the transaction server.

The present invention allows the transmission of further information about an object selected by the client, which further information is contained in an object attribute, from the presentation server to the transaction server. From the client to the transaction server only an ID is transmitted which allows access to the object attribute of the selected object. The object ID may be transmitted together with the URL of the transaction server for transmittal to the latter. Even if the user changes the ID he cannot change the object attributes as for example the price. Changing the ID disables the access to the object attribute(s) of the selected object; the object attribute(s) stored in the data base of the presentation server, however, remains unchanged. This allows a fast and correct execution of an online order or transaction.

Moreover, the attribute values may be updated at any time. The transaction server, using the object ID received from the client, accesses the latest updated version of the attribute using the ID.

The URL may contain a command for executing a specific process on the transcation server.

The transfer of the object ID together with the URL may be initiated by the user selecting a specific select button pertaining to the desired object.

The object attributes may be represented by numerical values and/or text strings.

The catalog or presentation server may be adapted to transmit the object data and object attributes to a client for display in different formats including XML, HTML, XHTML or WML formats.

Preferably an object selected by a client is stored in the database of the transaction server together with the corresponding attributes and a client specific session ID.

The present invention further provides a computer program as defined in claim 12 and a computer readable data storage medium as defined in claim 13.

The present invention still further proposes a computer system according to claim 14, a catalog server according to claim 15 and a transaction server according to claim 19.

Variations of the invention containing further preferred features are described in the dependent claims.

The present invention will more readily be understood from the following description of preferred embodiments with reference to the appended drawings, in which

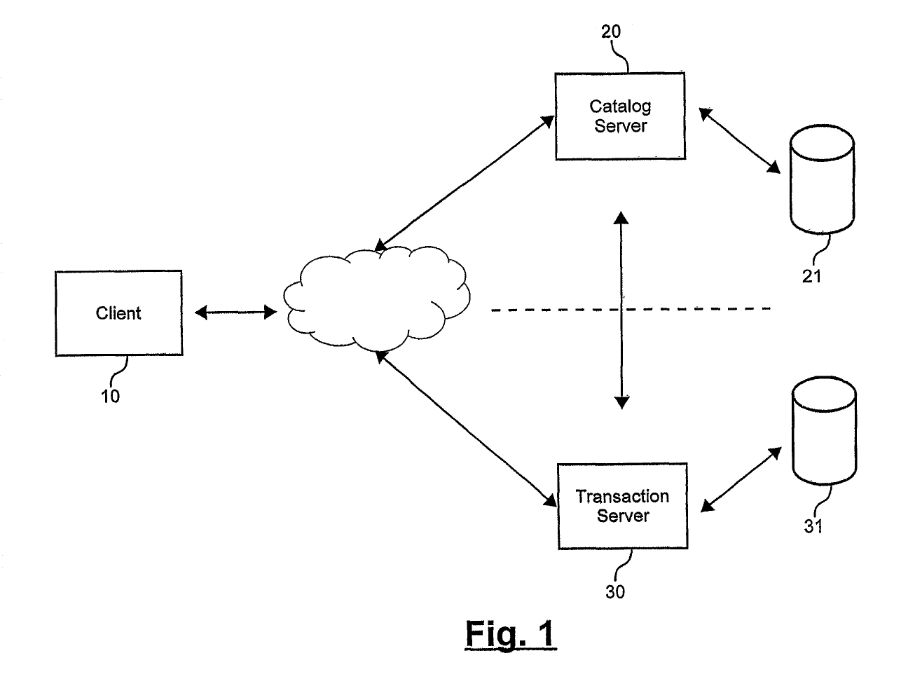

FIG. 1 is a schematic illustration of a computer system according to the present invention;

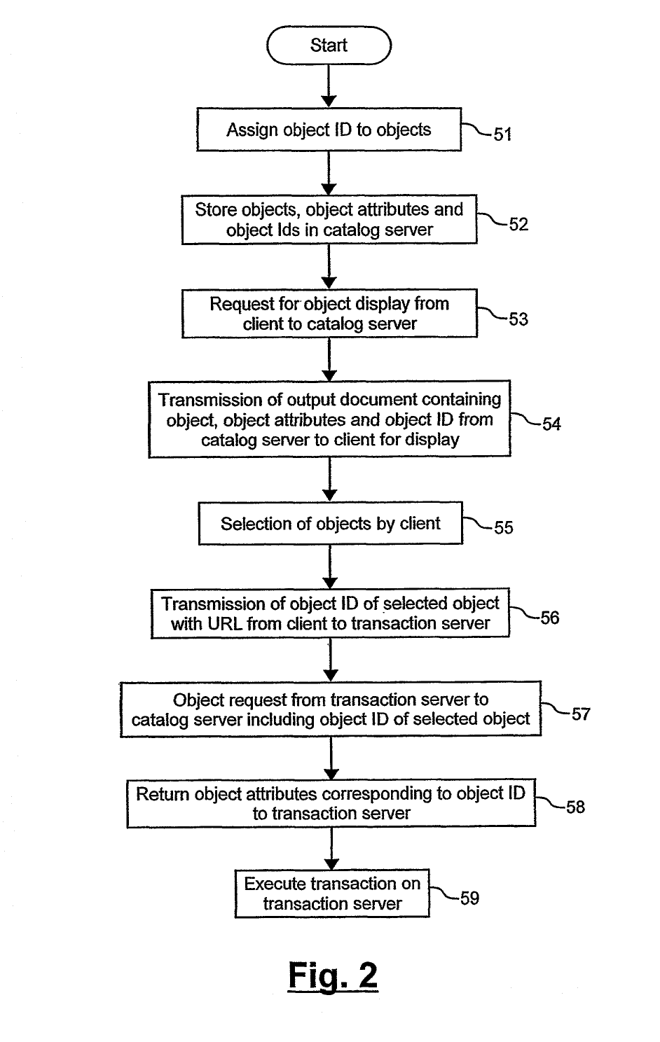

FIG. 2 is a flowchart showing method steps of an embodiment of the present invention;

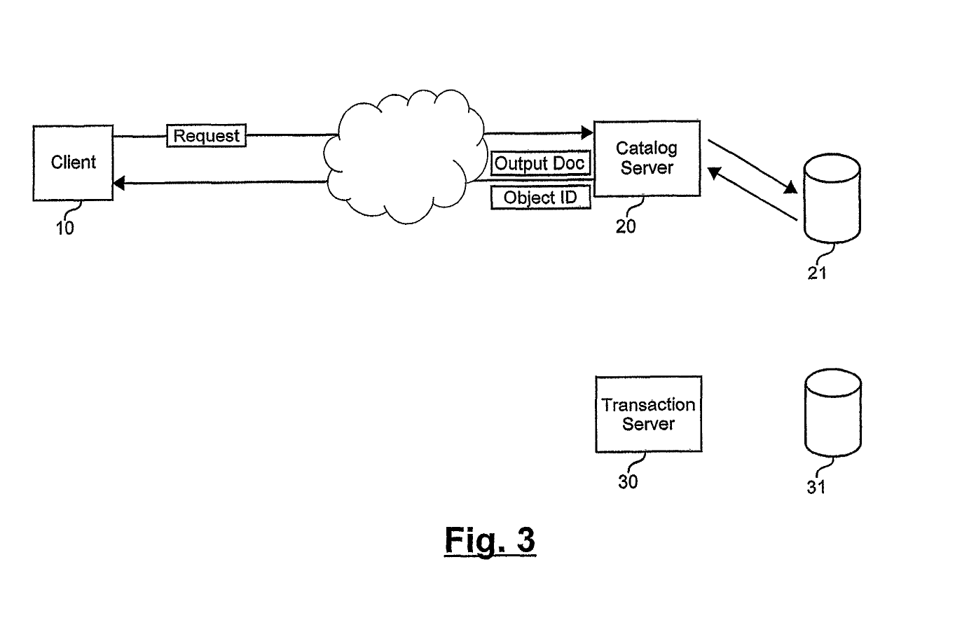

FIG. 3 is a schematic illustration of the transmission of the object ID to a client; and

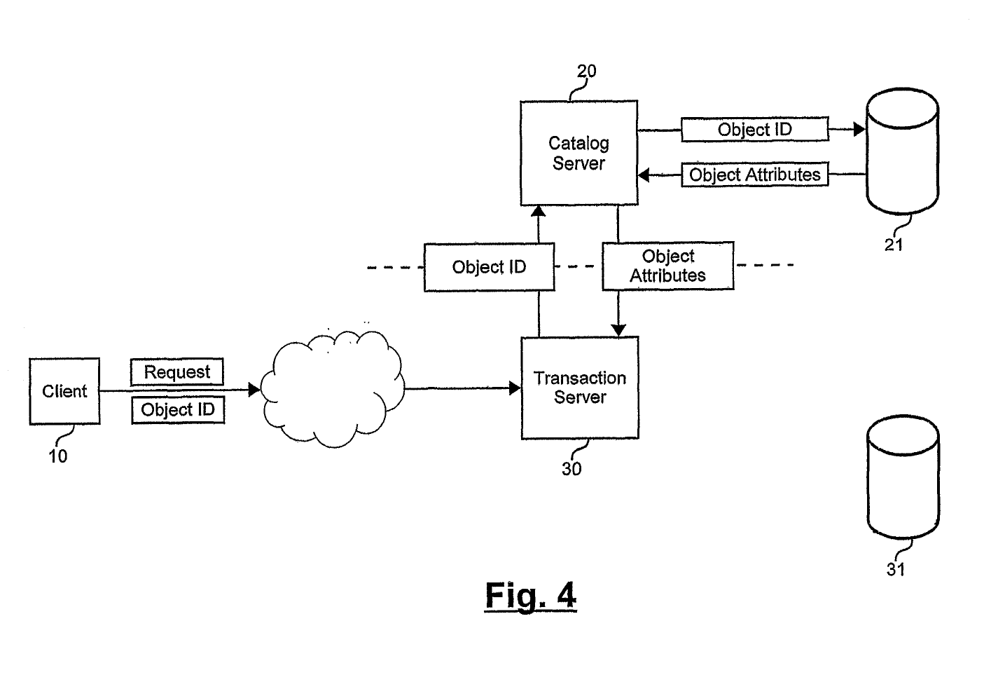

FIG. 4 is a schematic illustration of the transfer of object attributes from the catalog server to the transaction server using the object ID of the object selected by the user.

In the following a number of abbreviations used in the specification is explained briefly:

ID: Identifier

HTML: Hyper Text Markup Language

XML: Extensible Markup Language

WML: Wireless Markup Language

URL: Uniform Ressource Locator

XHTML: Extensible HyperText Markup Language.

FIG. 1 shows an illustrative example of the computer system according to the present invention. A catalog server or presentation server 20 is provided for storing, in a data base 21, data about objects for online transactions. These objects may be descriptions of tangible goods offered for sale like books or clothes, or may be the products themselves like recorded music or software for download. In addition to the object data there are stored object attributes containing additional information about an object like specific features, the price or references to similar other objects.

Separate from the catalog server 20 there is provided a transaction server 30 for executing an online transaction like a purchase, download etc. The transaction server 30 may also be equipped with a data base 31. Preferably the transaction server or order system 30 is connected to further computing devices, e.g. inventory management and delivery systems of a products manufacturer or seller. To separate catalog server and transaction server has the advantage of easier maintenance and scalability of the system. New products may be added or prices may be changed in the catalog server alone without affecting the transaction server. It is also possible to connect one transaction server with a plurality of catalog servers.

In order to carry out a transaction all necessary information like product specification, price, discounts, number of products and so forth which are stored in the catalog server must be transferred to the transaction server. That is, the object consisting of the object data and an object attribute (or a plurality of object attributes) containing additional information about the object have to be transmitted from the catalog server to the transaction server. According to the invention the attributes belonging to an object selected by user for an online transaction are transmitted from the catalog server upon request to the transaction server such that a client or user has no possibility to manipulate the attribute information. Therefore object attributes like the price etc. cannot be changed by the client.

The attributes belonging to an object selected by a user for an online transaction are then transmitted from the catalog server directly to the transaction server upon a request from the transaction server initiated by a request from a user which has been sent to the transaction server.

The method according to the present invention will be further described with reference to FIGS. 2, 3 and 4.

If a product or service supplier adds a new object to the catalog server 20 an object ID is assigned in order to identify this object (step S1). The object containing object data and object attributes and the object ID is then stored in the catalog server, preferably in the data base 21 (step S2). As data base 21 any suitable data base system may be employed. Preferably, the data are catagorized so that a user can easily find a desired item.

If a user using a client device 10 which may be a personal computer, a laptop, cellular phone or any other suitable device chooses one of the objects for display on a client display device, the object together with the object attributes are transmitted to the client in the suitable display format (step S4). This may be an XML. HTML, XHTML or WML format. The object is then presented on the display including information e.g. about object features, availability, price and so forth. Preferably a displayed object is assigned a specific button marked “choose object”, “into the shopping cart” or the like. If the user likes to include a product or service represented by the object he may click on this button to add the product or service to his or her order list. Connected with this button is an HTML tag including a URL (unified resource locator) of the catalog server.

After user selection the browser of the client device calls this URL which contains the address of the transaction server 30. In the latter an order list for the client including a client specific session ID is prepared.

FIG. 3 schematicly illustrates the display request from client 10 over the internet or any other suitable communication medium to catalog server 20. The catalog server then returns the output document containing the object including object attributes and the object ID to the client. If the client (or user) then selects a specific object (step S5 in FIG. 2), a request is transmitted to transaction server 30 (FIG. 4 and method step S6 in FIG. 2). This request contains the object ID assigned to the selected object. In the next method step, step S7 in FIG. 2, the transaction server requests from the catalog server the attributes of the selected object. For this request the respective object ID is transmitted to a catalog server which in turn transmits the object attribute back to the transaction server 30 (method step S8 in FIG. 2). The transaction server then has all necessary information for carrying out the transaction.

The user can then add further objects to his or her shopping list. In this case method steps S5 to S8 are repeated. On the other hand, the user may also cancel specific objects from the order list. To complete the transaction the user may be requested by the transaction server to forward a confirmation. If this confirmation is received by the transaction server all necessary steps can be carried out to complete the transaction.

With the present invention it is possible to transmit all necessary object information of a user selected object from the catalog server to the transaction server using the object ID. So the user cannot change the object attributes which may include sensible information as the price of the respective product or service. Furthermore, the object attributes may be continously updated in the data base 21 of the catalog server. With the object ID the transaction server always gets from the catalog server the most updated object attributes for carrying out the transaction.

1. A method of processing an online transaction over a communication network, comprising the steps of:
storing a plurality of objects comprising object data and object attibutes containing further information about the object in a catalog server (20) accessible by a plurality of clients (10),
displaying, upon request from a client (10), an object including object attributes on a client display, and
executing, on a transaction server (30), a transaction relating to an object selected by the client (10) using the information contained in the object attributes,
wherein the object attributes are transmitted directly from the catalog server (20) to the transaction server (30).

2. A method of processing an online transaction over a communication network comprising the steps of:
storing in a catalog server (20) a plurality of objects comprising object data and object attributes containing further information about the object and further storing an ID identifying the object,
transmitting upon request an object together with the corresponding object ID from the catlog server (20) to a client (10) for display,
receiving at the catalog server (20) an object request from a transaction server (30), the request including the object ID,
returning from the catalog server (20) to the transaction server (30) the object including object attributes corresponding to the received object ID.

3. A method of processing an online transaction over a communication network comprising the steps of:
receiving at a transaction server (30) a transaction request with respect to a specific object comprising object data and object attributes containing further information about the object, the request including an object ID identifying that object,
the transaction server (30) requesting the object from a catalog server (20), the request including the object ID,
receiving at the transaction server (30) from the catalog server (20) the selected object including object attributes, and
executing the transaction on the transaction server (30).

4. The method of claim 2 or 3, wherein the object ID is transmitted from the catalog server (20) to the client (1 0) together with the URL of the server (30).

5. The method of claim 4 wherein the URL additionally contains a command for executing a specific process on the transaction server (30).

6. The method of claim 4 or 5 wherein the object displayed on a client display is assigned a display field for user selection of the object, wherein the selection of the object by a user initiates a transfer of the ID to the URL of the transaction server (30).

7. The method of anyone of claims 1 to 6 wherein the object attributes are represented by numerical values and/or text strings.

8. The method of anyone of claims 1 to 7, wherein an object attribute represents price information about the object.

9. The method of anyone of claims 1 to 8 wherein the objects can be transmitted to the client for display in different formats including XML, HTML, XHTML or WML formats.

10. The method of anyone of claims 1 to 9 wherein an object selected by a client is stored on the transaction server together with the corresponding object attribute and a client specific session ID.

11. The method of anyone of claims 1 to 10 wherein the transaction server forwards to a client a request for finally confirming the transaction before executing the transaction.

12. A computer program comprising computer executable code for carrying out a method of anyone of claims 1 to 11.

13. A computer readable data storage medium containing a computer program comprising program code for carrying out a method of anyone of claims 1 to 11, when loaded into a computer.

14. A computer system comprising:
a catalog server (20) for storing a plurality of objects comprising object data and object attributes containing further information about the object, and for storing an object ID identifying an object, the catalog server (20) being accessible by a plurality of clients, and
a transaction server (30) accessible for a plurality of clients (10) for executing online transactions with respect to the objects stored in the catalog server (20),
wherein the object attributes are transmittable directly from the catalog server (20) to the transaction server (30) without client interaction.

15. A catalog server (20) comprising
a storage unit (21) for storing objects for online transactions, the objects comprising object data and object attributes containing further information about the object, wherein the objects are assigned object IDs identifying the object, and
an output unit for outputting at least one object attribute upon receiving the corresponding object ID.

16. The catalog server of claim 15 wherein the object attributes are represented by numerical values or text strings.

17. The catalog server of claim 16 wherein the object attributes contain price information about the object.

18. The catalog server of anyone of claims 15 to 17, wherein the stored objects can be transmitted to a client for display in different formats including XML, HTML, XHTML and WML formats.

19. A transaction server (20) for executing online transactions over a communication network comprising a processing unit for
receiving a transaction request from a client (10) requesting an online transaction relating to a specific object, the request containing object data and an object ID identifying the object,
requesting from a catalog server (20) object attributes containing further information about the object selected by the users the request containing the object ID, and
executing the online transaction using the information contained in the object attributes received from the catalog server (20).

20. The transaction server of claim 19 further comprising a confirmation unit forwarding to the client (10) a confirmation request, and executing the online transaction only after having received a confirmation from the client (10).
